(19) United States
(12) Patent Application Publication
(10) Pub. No.: US 2006/0282355 A1
(43) Pub. Date: Dec. 14, 2006

(54) Actively managed credit linked note program

(75) Inventors: Rene Canezin, Woodbury, NY (US); Vincent Basulto, Port Washington, NY (US); Paul Mitrokostas, Chatham, NJ (US); C. Michael Weaver, New York, NY (US); Setareh Mirhosseini, New York, NY (US); Elena Ranguelova, Jersey City, NJ (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Lehman Brothers, Inc., New York, NY (US)

(21) Appl. No.: 10/404,517

(22) Filed: Apr. 1, 2003

(51) Int. Cl. G06Q 40/00

(52) U.S. Cl. 705/35

(57) ABSTRACT

A financial investment product that allows an investor to take leveraged exposure to a customized, dynamic pool of credits and earn an enhanced yield. The product consists of a special purpose vehicle, such as a trust, containing one or more underlying assets and a portfolio of diversified credit default swaps. The notional of the outstanding portfolio of default swaps is a multiple of the notional of securities issued by the trust, which creates the leverage. The leverage is non-recourse to the investor and can be either increased or decreased during the life of the trade.

### FIELD OF THE INVENTION

The invention generally relates to a financial product and method for investing in capital markets through an investor-managed and leveraged portfolio of credit default swap transactions.

### BACKGROUND OF THE INVENTION

Credit derivatives constitute an increasingly popular group of innovative products that facilitate separation of credit risk from an underlying financial instrument. As described in greater detail below, credit default swaps are bilateral, over-the-counter, off-balance sheet financial instruments that allow one party (the risk seller or protection buyer) to transfer the credit risk of a “reference entity” or “reference asset,” which it may or may not own, to another party (the protection seller or guarantor) without actually selling the asset. The protection buyer agrees under a credit default swap to pay a fee to the protection seller, in return for a contingent payment by the seller following a credit event concerning a reference entity. The contingent payment is a payment made by the protection seller upon the occurrence of a particular credit event regarding the reference entity, such as a bankruptcy, insolvency, receivership, or other failure to meet payment obligations. In other words, credit derivatives enable investors to efficiently transfer and repackage the risk of a credit event. The reference assets may include bank debt, corporate debt, high-grade sovereign debt and emerging-market debt.

Default swaps are advantageous for various reasons. They may be used to hedge credit risk, diversify credit risk, earn spread income, or to free up regulatory capital. Credit default swaps thus ultimately provide a more efficient way to replicate the credit risk than exists for a standard cash instrument, such as a bond. Specifically, one advantage of a credit default swap over the conventional purchase of a bond is that a credit default swap is unfunded, customizable and confidential. Moreover, buying protection in a credit default swap is a practical and liquid way to short credit risk, thus providing a range of applications in relation to hedging credit risk.

Credit derivatives may also provide flexibility in tailoring the terms of particular investments to the diverse time horizons of investors, particularly where the terms of standard investments and the preferred time horizons are not aligned. For example, credit derivatives allow an investor with a 5-year time horizon to take the first five years of risk of a 10-year corporate bond, and a second investor to take the second five years of risk. Thus, to institutional investors, credit default swaps represent a new asset class that can be engineered to meet varying demands. Additionally, an entity such as a bank can employ credit swaps to reduce credit exposure without actually removing assets from its balance sheet.

In its simplest form, a credit default swap provides a more efficient way to replicate the credit risk of an entity than exists for a standard cash instrument, such as a bond. These transactions are sometimes called single-name credit derivatives, as the reference assets belong to a single issuer (corporate or sovereign).

In a more complex “multi-name” form, credit default swaps allow investors to split up the credit profile of an entire group or pool of assets issued by different corporations or sovereigns into tranches with different risk profiles. Then, holders of large credit portfolios, typically banks, can securitize the group or pool of assets, and so remove large swaths of their credit risk from their balance sheets. This process of securitization transfers this risk into the capital markets. While these structures are generically known as Collateralized Debt Obligations (CDOs), the credit derivative version is known as a Synthetic CDO. For the investor, these structures are a new class of portfolio credit product that can be tailored to their precise risk-return characteristics.

From the standpoint of the investor in credit derivatives (either single name, or “multi-name” form), the compensation required for a protection seller to assume a credit risk should be approximately equal to the probability of default multiplied by the expected recovery in the event of default. The compensation is measured in terms of the spread above the similar maturity LIBOR swap rate which an investor will demand in return for assuming credit risk. This concept is illustrated by the “credit triangle” of FIG. 1. As illustrated, the credit spread (S) can be shown to be a function of the market-implied probability of default (P), and the market implied expected recovery rate in the event of default (R). The spread will be higher (lower), for a higher (lower) probability of default. It will also be higher (lower) with a lower (higher) expected recovery.

The mechanics of a credit default swap are illustrated in FIGS. 2a-c. Specifically, as illustrated in FIG. 2a, a protection buyer pays a premium, or “default swap spread,” until a credit event occurs or the credit swap matures. If a credit event occurs, there are two possible scenarios for compensating the protection buyer (settlement), and the one to be used must be specified at the initiation of the contract.

FIG. 2c illustrates physical settlement, which is a current market standard for single name credit default swaps. This involves the protection buyer delivering the notional of the underlying “deliverable obligations” to the protection seller in return for the notional paid in cash. Deliverable obligations are the bonds and/or loans of the reference entity that satisfy the characteristics specified in the default swap agreement. In a full default, all bonds and loans ranked equally in the capital structure would likely trade at or around the same value. However, in a restructuring event, these assets may continue to trade with a price differential, which has the effect of creating a cheapest-to-deliver option in which the protection buyer may choose to deliver the obligation with the lowest price to the protection seller in return for par.

FIG. 2b illustrates cash settlement, which is less frequently specified than physical settlement. In this case, the payout of the contract following a credit event is calculated as the notional minus the recovery rate of the reference asset. The recovery rate is calculated by referencing dealer quotes or observable market prices during some pre-specified period after default has occurred.

Credit default swaps, therefore, present an efficient way to repackage and reallocate credit risk. They may be advantageously used in various scenarios, including as a hedge against concentrated risk. A bank with a high concentration to a single borrower, for example, may purchase protection in default swap format to hedge out part or all of its exposure. As long as the maturity of the protection is at least as long as that of the risk being hedged, current banking regulations will accept a default swap contract as a full credit offset requiring capital to be held only against the counterparty risk of the protection seller, which typically means a reduction of capital held from 8% of notional to 1.6%.

Default swaps are also private transactions between two counterparties, whereas selling a loan may require customer consent or notification. This is beneficial from the standpoint of a bank's relationships with it borrowers. Default swaps may be used to hedge credit exposures where no publicly traded debt market exists, which is advantageous, given the poor liquidity of particular loan markets. As mentioned above, default swaps are an unfunded way to take credit risk, making it easier for investors with high funding costs to increase their credit exposure efficiently. Default swaps may also be customized to match an investor's precise requirements in terms of maturity and seniority.

Additionally, though they are only triggered by credit events, the value of a credit default swap contract changes as the market's view around the credit quality of a reference entity changes. As a result, a credit default swap can be used to take a view on either a deterioration or improvement in credit quality of the reference entity. Further, dislocations between the cash and derivatives market can make the credit default swap a higher-yielding investment than the equivalent cash instrument.

Accordingly, the use of credit default swaps provides many advantages for investors. However, it would be further advantageous for an investor to establish a bilateral counterparty credit default swap transaction relationship, particularly one in which the investor can select and actively manage the reference entities of the default swaps, and in which the investor can leverage his investment to maximize return.

### SUMMARY OF THE INVENTION

The invention provides a system and a method for an investor to invest in a portfolio of credit default swap transactions by funding a special purpose vehicle (SPV) with an initial investment, wherein the total default swap notional of the portfolio exceeds the investor's investment and wherein the investor may select and actively manage the reference credits that comprise the portfolio. According to one embodiment of the invention, the invention takes the form of credit linked notes or other securities (CLNs) in which the SPV is an investor-funded trust that issues CLNs having a principal balance equivalent to the investor's investment. The trust enters a credit default swap with a counterparty which can be any entity willing to buy and/or sell credit protection. However, in a highly preferred embodiment of the invention, the second counterparty to all of the default swaps within the portfolio is a single investment banking firm with established market credentials.

In a preferred embodiment of the present invention, the trust purchases an underlying security in the amount of the initial investment. This underlying security may take the form of a high-investment-grade financial instrument, such as an insurance company bond. The trust, at the direction of the investor, buys or sells default protection for specified reference credits in return for receiving or paying a premium through a series of default swaps. Each default swap in the series is based upon a particular reference credit, which is often an investment-grade rated corporate entity.

After the trust is funded, it issues an initial principal amount of securities in the amount of the initial investment. From time to time, the trust may issue additional securities. The investor thus securitizes the initial investment and the value of the trust. This is advantageous because the investor will own a security which may be traded and valued.

In the embodiment in which the trust sells protection, the trust receives premium payments from the swap counterparty until the relationship between the counterparties terminates, which occurs when the trust dissolves. The trust dissolves either after a length of time agreed to by the counterparties, i.e., maturity, or upon an event agreed to by the counterparties. For example, the trust may be dissolved in the event that the marked-to-market value of the default swaps falls below a specified trigger level. Alternately, the trust may dissolve upon default with respect to the underlying security or upon request of the investor.

The portfolio of credit default swaps is based on a pool of reference entities, which the investor may select from capital markets in general, or from a selection of entities provided by the swap counterparty, or as agreed to by both counterparties. A feature of one embodiment of the invention is that it allows the investor to actively manage the portfolio of reference credits. That is, the investor may select the reference entities at the initiation of the trust, and may also move other reference entities into and out of the portfolio during the life of the trust. This is advantageous for the investor, as it allows for tailoring the aggregate creditworthiness of the reference entities to the risk tolerance of the investor, over the life of the relationship.

The invention also allows the investor to leverage an investment, which leverage is provided by the trust's swap counterparty. Without such leverage, the investor is limited to a total default swap notional that is equivalent to the principal amount of the CLNs. However, by using a willing investment banking firm as the swap counterparty, an investor may participate in a series of default swaps which total default swap notional exceeds, e.g., by a predetermined multiple, the investor's investment in the trust. The default swap notional in excess of the notional of the CLNs issued by the trust represents leverage. As a result, the invention allows an investor to participate in a pool of credit default swaps that has a market value many times greater than the initial investment. The investor's risk, however, is capped by the investment in the trust, and in a preferred embodiment of the invention, the parties to the default swaps have no recourse against the investor, i.e., there is no legal right for the parties to the default swap to recover or secure performance from the investor.

Upon the occurrence of a credit event with respect to a reference entity, the swap counterparty may deliver a face amount of deliverable obligations of the related reference entity equal to the notional value of the reference entity less an adjustment amount based on the value of the underlying security. Alternatively, the swap counterparty may provide a cash or security equivalent.

### BRIEF DESCRIPTION OF THE DRAWINGS

FIG. 1 is a block diagram representation of a credit triangle.

FIG. 2 is a block diagram representation of a typical default swap transaction.

FIG. 3 is a block diagram representation of certain components to a financial product designed according to the invention.

FIG. 4 is a block diagram representation illustrating events occurring at the settlement date of a financial product designed according to the invention.

FIG. 5 is a block diagram representation illustrating the income flow to an investor over the life of a financial product designed according to the invention.

FIG. 6 is a block diagram representation illustrating an investor posting collateral during the life of a financial product designed according to the invention.

FIG. 7 is a block diagram representation illustrating the “unwinding” of a financial product designed according to the invention.

FIG. 8 is a block diagram representation illustrating the termination of a special purpose vehicle, such as a trust, upon maturity of a financial product designed according to the invention.

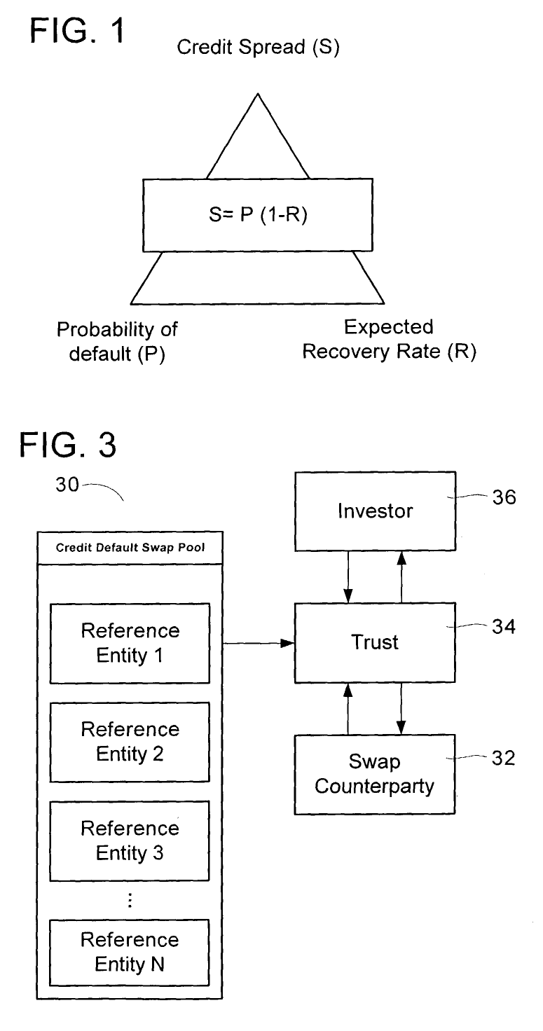

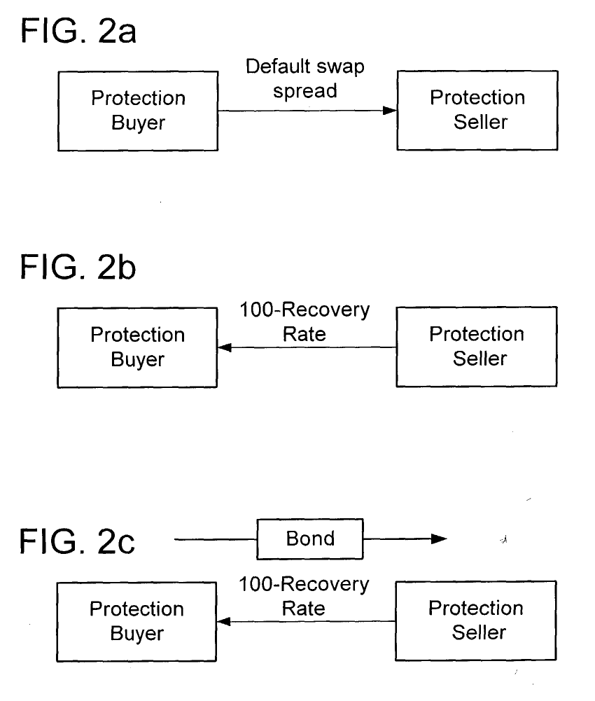

### DETAILED DESCRIPTION OF THE INVENTION

In a preferred embodiment of the invention, an investor is permitted to leverage, or multiply, an investment in a portfolio of credit default swap transactions (“default swaps”), which portfolio is not fixed in time and may be actively managed by the investor. The present invention thus permits a more flexible product and method for investing in default swaps than previously known. By employing an established and reliable entity as the swap counterparty for market transactions involving the default swaps, the invention obviates the need for each potential investor to independently establish its financial credentials to the market. Additionally, the present invention provides increased investment leverage over alternative investments, such as those available through traditional repurchase (repo) transactions, while simultaneously providing the investor with the ability to actively manage the portfolio credit references.

FIG. 3 illustrates one such preferred embodiment of the invention. In this embodiment, an investment product or “trade” 30 is comprised of a swap counterparty 32, a special purpose vehicle (SPV), such as a trust 34, an investor 36, and a portfolio of credit references. Swap counterparty 32 is an entity, such as an investment banking firm, that has established sufficient market credentials to trade in the default swap capital markets.

Investor 36 may be a single investor or several investors who seek to invest in trade 30. Investor 36 may customize and actively manage a pool of credit references 38, for which credit protection may be bought or sold. The special purpose vehicle, such as trust 34, sells or purchases credit protection to or from swap counterparty 32 in regard to each default swap transaction. Investor 36 selects the portfolio of default swaps from a group of available reference credits, which may be determined by the swap counterparty 32 for trade 30. Trade 30 may have a fixed lifetime, i.e., a fixed maturity date, or may provide for a maturity date which may be extended upon election of Investor 36. In the latter case, trade 30 will typically exist as long as Investor 36 and swap counterparty 32 agree, the special purpose vehicle is adequately funded and other criteria remain satisfied.

Swap counterparty 32 may coordinate several aspects of trade 30. For example, it may assist investor 36 set up the trust. In addition, swap counterparty 32 may provide additional services for investor 36, such as acting as an “intermediary” between the trust and other market counterparties (not shown) in connection with default swap transactions involving the portfolio. In exchange for participating in trade 30 and offering its other services, swap counterparty 32 may require payment of a periodic administration fee. In such embodiments, the fee may be fixed or set as a percentage of the total default notional in the trade. As an example of the latter, swap counterparty 32 may charge twenty-five (25) basis points or other such percentage as will be agreed between the parties.

Before investing in trade 30, or during its lifetime, the parties may agree to various terms and provisions. For example, they may agree to specify key terms and provisions such as predetermined credit events, maturity term, termination events, number and quality of reference credits in the pool, or the leveraged notional amount. The leveraged notional amount is initially a multiple of the investor's investment in product 30. The particular multiple may be predetermined, determined by negotiation between the investor and swap counterparty, or may be established by reference to external factors. The parties also may agree to limit the minimum or maximum number of credit references in pool 38 as well as the credit quality of the references. The leveraged notional amount may also float, i.e., increase and decrease, during the life of trade 30.

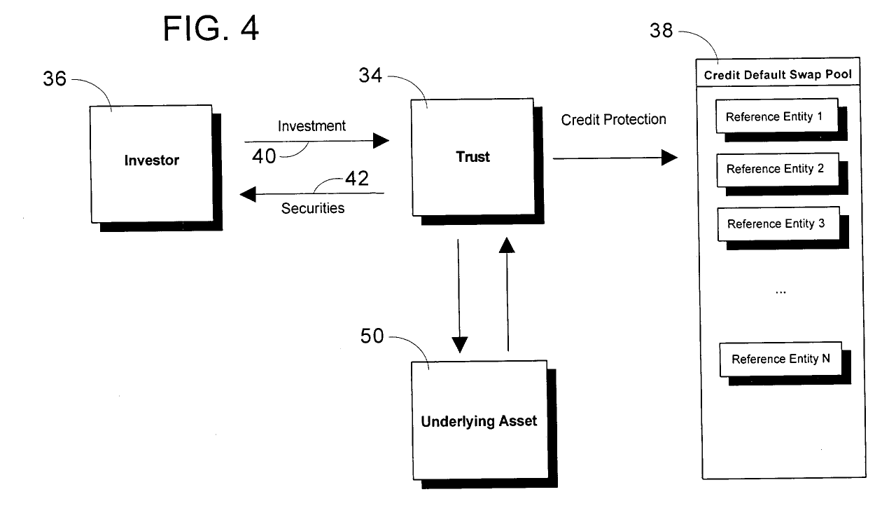

FIG. 4 illustrates the events occurring between the constituent parts of trade 30 at the settlement date of an SPV, such as trust 34. Investor 36 supplies an investment to the trust which, in turn, issues securities or certificates. Typically, although not always, the notional of the issued securities or certificates is equivalent to the investment. Arrow 40 represents the investment transferred from investor 36 to trust 34 in exchange for the securities or certificates represented by arrow 42. As to the quantity of securities/certificates, trust 34 may issue a single security/certificate, or a plurality of them. The trade 30 is thus securitized. Investor 36 may, in turn, sell the securities/certificates in an appropriate market. In a highly preferred embodiment of the invention, trade 30 is organized as a Credit-Linked Notes (“CLNs”) financial investment product.

Another event occurring on the settlement date, as illustrated in FIG. 4, is the trustee's purchase of an underlying asset 50. Underlying asset 50, which may or may not be of equal par value to the investment, is typically a stable, highly-market-rated security, such as a bond that pays a fixed or floating coupon. In a preferred embodiment, the par value of asset 50 is exactly equal to the investment on the settlement date. In other embodiments, however, the par value of asset 50 is less or more than the investment on the settlement date. Investor 36 receives the coupons paid by underlying asset 50 over the life of trade 30. It is to be understood that, in keeping with the inventive scope, other securities may be purchased as underlying asset 50 for the trust 34. Moreover, more than a single security may constitute underlying asset 50, and underlying asset 50 may provide a yield other than coupons, or no yield at all.

The strength, i.e., quality, of underlying asset 50 is significant because upon termination or maturity of trade 30, underlying asset 50 and pool 38 of credit default swaps are liquidated. The underlying asset thus provides investor 36 with independent protection against the swap counterparty's default. At termination, investor 36 receives the proceeds from the liquidation of the underlying asset 50 less the mark-to-market amount of the credit default swap pool.

In the embodiment of FIG. 4, trust 34 offers credit protection to swap counterparty 32, through the portfolio of default swaps, on a leveraged notional amount. It should be understood, however, that trust 34 could also purchase credit protection on the portfolio of default swaps in an alternative embodiment. The leveraged notional amount is a multiple of the principal of the issued securities, or issuance proceeds. The parties to the trade 30 may agree to a predetermined multiple before entering the trade 30. The predetermined multiple determines the limit of the default swaps notional. The leverage multiple may range, for example, from six to thirteen times the notional of the certificates issued by the trust. However, in keeping with the inventive scope, the leverage multiple is not limited to the values set forth herein, and may be set as any whole number or fractional multiple agreed upon by the parties to the trade. Moreover, in another embodiment of the invention, the leverage may be specified as non-recourse to investor 36.

As a concrete example of trade 30 in FIG. 4, an investor may pay $10 million (U.S.D.) into the trust for an equivalent notional of certificates. Trust 30 may thereafter offer credit protection to the swap counterparty 32 up to a predetermined leveraged notional amount of $80 million (U.S.D.) based on the portfolio of credit default swap transactions selected by investor 36. In this example, the leverage is eight times the initial investment.

The portfolio of credit swap transactions corresponds to pool 38 including a number, N, of reference entities selected and actively managed by investor 36. Pool 38 may include, for example, twenty (20) reference entities. However, the parties to the trade 30 may agree to include any number of reference entities in pool 38. The reference entities may also be selected from predetermined group of reference entities agreed upon by the parties. For example, the parties may agree to select only reference entities that meet particular creditworthiness standards, such as those set forth by Moody's Investors Service, Inc. and other such entities. Additionally, the invention contemplates that the parties may agree to cap the notional of a particular reference entity and/or the notional of the reference entities corresponding to a particular industry in pool 38. In still another embodiment, the reference entities may be selected by investor 36 only after the swap counterparty 32 has consented to the default swap transaction.

An advantageous feature of the present invention is the ability of investor 36 to actively manage the reference entities included in pool 38 over the term of trade 30. That is, investor 36 can add and subtract reference entities to and from the pool 38 over the life of trade, 30, thus actively controlling his credit exposure. Accordingly, the leveraged notional amount may fluctuate relative to the principal of the issued securities over the life of trade 30, because the value of the individual default swaps fluctuates over time.

As a result of these fluctuations, trade 30 may have an established maximum “trigger” leverage multiple that is different from the initial leverage multiple. For example, trade 30 with an initial leverage multiple of 8 may be terminated if the leverage multiple rises to a predetermined “trigger” of 13 times the principal of the issued securities. Of course, it is to be appreciated that the “trigger” multiple is not limited to 13, but can be any integer or fraction agreed to by the parties.

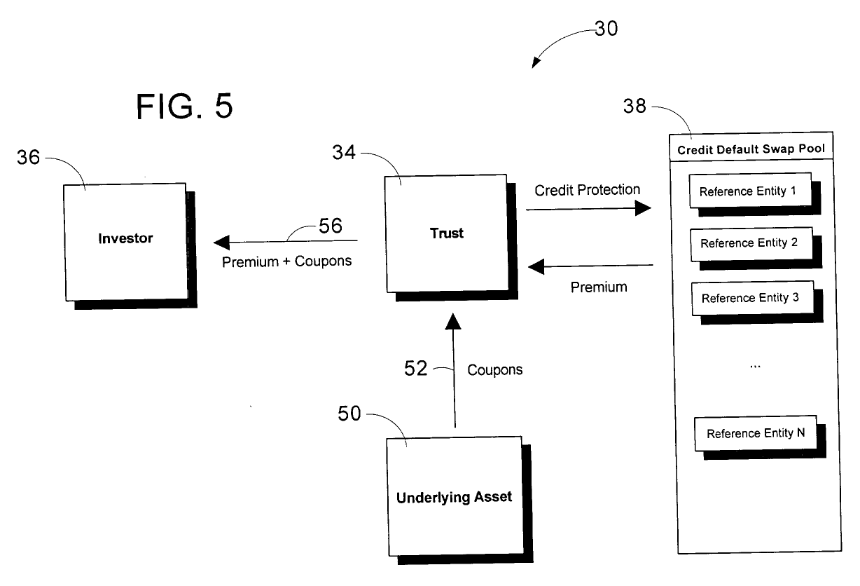

FIG. 5 illustrates the income flow to investor 36 over the life of trade 30. Specifically, the coupons or other yield of underlying asset 50 flow into trust 34, along with the premiums paid into trust 34 by the protection buyer for the default swaps in pool 38, as represented by arrows 52 and 54, respectively. Investor 36 receives these payments (on the basis specified by underlying asset 50 and on a periodic basis for the default swaps) as an income stream from the trust 34, represented as arrow 56. During the life of trade 30, investor 36 may also choose to trade in and out of individual credit default swaps in pool 38. As a result, the income stream from the default swap portfolio fluctuates as reference credits are added and subtracted to and from the portfolio. In one embodiment of the invention, investor 36 can use the premiums flowing into trust 34 from long positions to pay for establishing a short position on different reference credits. Thus, pool 38 may further involve reference credits in which trust 34 and counterparty 32 have either a long or short position.

As part of the active management feature of trade 30, default swap pool 38 is marked to market frequently, which insures that adequate levels of collateral are maintained in the trade and further permits investor 36 frequent opportunities to evaluate the performance of the portfolio. In a preferred embodiment of the invention, this marking to market may occur every day. It is to be appreciated, though, that other time intervals may be specified for marking to market the pool 38. For example, in other embodiments, marking to market may occur weekly, monthly, quarterly, or at any other agreed frequency.

In a preferred embodiment of the invention, swap counterparty 32 will deliver to trust 34 a face amount of obligations upon the occurrence of a credit event with respect to a reference entity. The amount of such obligations will be equal to the notional value of the reference entity less the underlying security adjustment amount. This is the difference between the notional of the reference entity and the termination market value of the equivalent notional of underlying security 50 divided by the termination market value of the reference entity expressed as a percentage of par. The termination market value, in turn, may be determined by the parties as the bid price of the security determined as the average of a number of solicited bidders, e.g., three, for such security as ascertained by the swap counterparty 32. In an alternative embodiment, swap counterparty 32 delivers to trust 34 an equivalent cash value of the obligations rather than delivering the actual obligations in the event of a default.

Upon a credit event, the trustee will deliver to the swap counterparty an amount equivalent to the par value of the underlying credit reference. This amount may be satisfied by liquidating the underlying security 50 or by requiring an additional investment or collateral from the investor. Further, the trustee will distribute the deliverable obligations (or cash equivalent) to the holders of the credit-linked notes or certificates.

In a highly preferred embodiment, the swap counterparty's recourse, in the event of a default, is ultimately limited to the amount in trust. Moreover, in this embodiment, swap counterparty 32 has no recourse against the investor, thus making the product 30 more advantageous to investors 36 than traditional credit default swaps or alternative investments.

In another embodiment of the invention, a credit event relating to the reference entity may be the occurrence of a bankruptcy or insolvency, the failure to pay on an obligation, or a debt restructuring. However, it is to be understood that the invention is not limited to the credit events described herein. In contrast, the parties to trade 30 may agree that credit events may also include such activities as an acceleration or default of an obligation, a repudiation of an obligation, a moratorium on payments, the downgrade of a rating, a change in credit spread, or some other event regarding a reference entity.

Based on agreement of the parties, trade 30 may be terminated or “unwound” upon the earlier of a predetermined maturity date or the occurrence of a predetermined termination event. The termination event may be that investor 36 requests termination of the trust. Swap counterparty 32 may require investor 36 to pay a fee to terminate the trade 30 before maturity, but this is not a requirement of the invention. The ability of investor 36 to terminate or “call” trade 30 is a particularly advantageous feature of the invention, but is also not a requirement.

Another “triggering” event may be a predetermined credit event relative to the reference credits, or the default with respect to the underlying asset 50. Alternately, the parties may agree to terminate the trade 30 if its market value falls below a predetermined “trigger” level. In certain embodiments of the invention, the predetermined “trigger” level may be a percentage of the amount invested in the trust. For example, the parties may agree to terminate trade 30 if the market value of pool 38 falls below 60% of the amount invested in the trust 34. Of course, the parties may agree to set the percentages and reference values of the “trigger” level as they wish. For instance, the “trigger” value may be any percentage of an agreed-upon reference value, such as the value of the portfolio on a particular date. Alternately, the reference value against which the percentage is taken may be the value of the underlying asset 50, or, potentially, a financial benchmark such as a published interest rate.

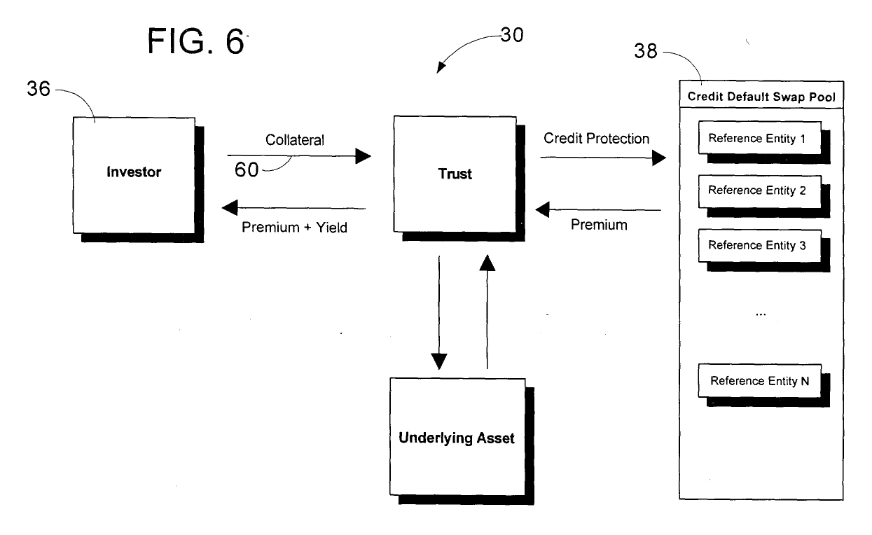

In still another embodiment of the present invention, investor 36 in trade 30 may post collateral during the life of the trade 30, as illustrated particularly at arrow 60 in FIG. 6. The ability to post collateral may be advantageous to investor 36 if, for example, the value of the credit default swap portfolio has fallen significantly, and investor 36 wishes to keep it from falling below the “trigger” level. If investor 36 elects not to post collateral and the value of the trade 30 falls below the “trigger” level, the trade 30 will be unwound at the value levels at the time of “triggering.” Alternately, the parties may agree to allow investor 36 to post collateral after the “triggering,” at the discretion of swap counterparty 32. Additionally, the collateral may be returned to investor 36 if the market value of the portfolio rises above the trigger level.

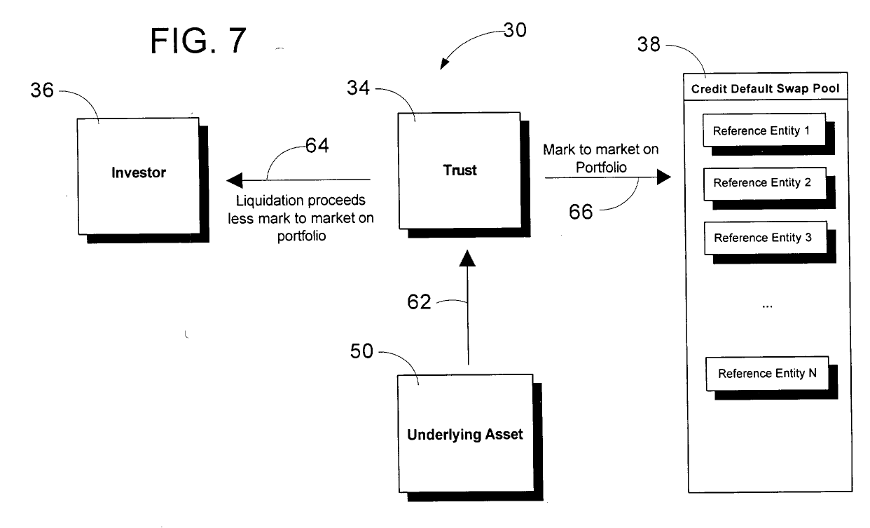

FIG. 7 illustrates the unwinding of the trade 30 if the market value of credit default swap pool 38 falls below the “trigger” level or some other termination event occurs, such as the investor's request to terminate or a default with respect to the underlying security 50. In the embodiment of FIG. 7, upon occurrence of the “triggering” event, underlying asset 50 will be liquidated at its market value, and credit swap pool 38 will be unwound at its market value. The proceeds from liquidation of underlying asset 50 then flow into trust 34, as represented by arrow 62. Trust 34 pays investor 36 the liquidation proceeds less the mark to market amount on default swap pool 38. Arrow 64 illustrates the flow of this amount to investor 36. The mark to market amount on credit default swap pool 38 flows to swap counterparty 32, as represented by arrow 66. Finally, any collateral posted during the life of trade 30 is returned to investor 36.

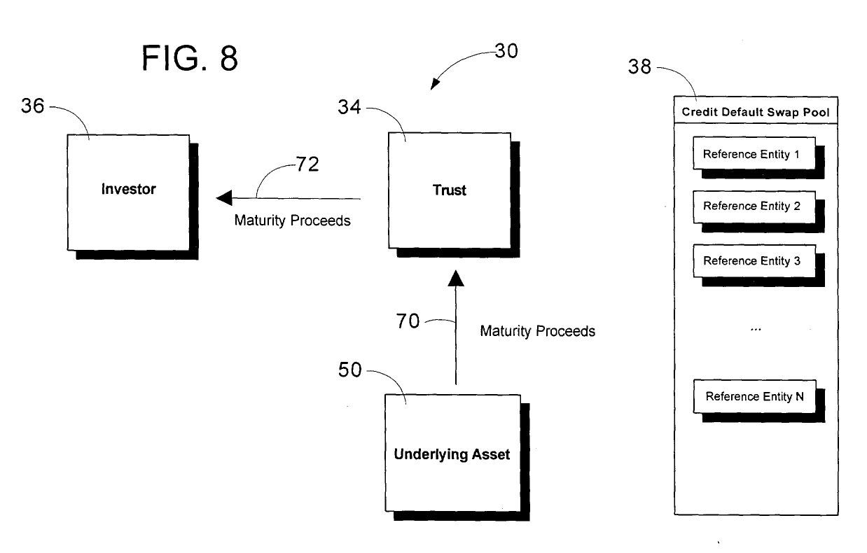

FIG. 8 illustrates the termination of trust 34 upon maturity of trade 30. In this embodiment of the invention, the underlying terms of trade 30 may include a maturity date on which the underlying asset matures and its proceeds are paid to investor 36 via trust 34. The maturity date may be a predetermined date or it may be measured from any point in time agreed upon by investor 36 and swap counterparty 32. For example, in one embodiment of the invention, the predetermined maturity date may be 5 years after the first CLN is issued. Of course, other terms and other maturity dates are contemplated within the scope of the invention. Alternately the maturity date may be some predetermined number of days or months after a date other than issuance of the first CLN.

Upon maturity, as indicated by FIG. 8, the flow of the proceeds into the trust is represented by arrow 70 and the payment of these proceeds to investor 36 by trust 34 is represented by arrow 72. The individual default swaps in pool 38 also mature, and the trust 34 terminates. Finally, any collateral posted during the life of the trade 30 is returned.

In certain embodiments of the invention, an investor may be able to achieve significantly better accounting treatment under trade 30 than would be available from other financial transactions, such as a standard repurchase financing transaction. For example, under generally accepted accounting principles (“GAAP”), an investor obtaining leverage through traditional bond financing may have to report on its balance sheet the full notional of the outstanding default swaps whereas an investor in trade 30 may have to report on its balance sheet only the amount of invested cash, not the entire leveraged amount.

In addition, depending on relevant regulations, an investor in trade 30 may be able increase the maximum value of default swaps transactions in which it can engage. For example, relevant regulations may require capital to be allocated for the total notional of outstanding default swaps. In trade 30, however, the investor is removed as a party from the default swaps, and as such, the relevant regulations may require capital to be allocated only for the principal value of invested cash. Although the foregoing examples are illustrative only, and GAAP or relevant regulations may require different treatment in an actual transaction, trade 30 may provide these and other advantages known to persons skilled in the art.

Thus, the invention provides a method for investing in credit default swaps between an investor-funded trust and a swap counterparty, such that the method allows an investor to customize and manage a dynamic pool of reference credits. This method allows an investor to significantly leverage his initial investment to enhance its yield, and is available to many investors that may otherwise be precluded from participating in credit default swap transactions for various reasons.

While this invention has been described with an emphasis upon particular embodiments, it should be understood that the foregoing description has been limited to the presently contemplated best mode for practicing the invention. It will be apparent that various modifications may be made to the invention, and that some or all of the advantages of the invention may be obtained. Also, the invention is not intended to require each of the above-described features and aspects or combinations thereof. In many instances, certain features and aspects are not essential for practicing other features and aspects. The invention should only be limited by the appended claims and equivalents thereof, since the claims are intended to cover other variations and modifications even though not within their literal scope.

What is claimed is:

1. A derivative financial investment product comprising an investor-managed pool of credit derivative transactions having a total notional that exceeds the amount invested by the investor, wherein the parties to the credit derivative transactions have no recourse against the investor in the event of a default.

2. A method for facilitating investments comprising entering into default swap transactions for an investor-selected portfolio of reference credits, wherein the total default swap notional exceeds the amount invested by the investor and wherein the parties to the swap transaction have no recourse against the investor.

3. A method for facilitating investments comprising:
a. creating a trust that administers securities having an aggregate principal balance that is equal to an amount invested by investors in the trust, and
b. entering into a series of default swap transactions for a portfolio of reference credits that is selected by investors in the trust, wherein the total default swap notional exceeds the amount invested in the trust and wherein the parties to the swap transaction have no recourse against the investors in the trust in the event that one or more reference credits defaults.

4. The method of claim 3 wherein the securities are Credit Linked Notes (CLNs).

5. The method of claim 4 wherein the number of investors in the trust is one and the number of CLNs is one.

6. The method of claim 3 wherein the swap counterparty is an investment bank.

7. The method of claim 3 wherein the credit references are selected by the investors only after the swap counterparty has consented to the default swap transactions.

8. The method of claim 3 wherein the total default swap notional value cannot exceed a predetermined multiple of the amount invested in the trust, which multiple is determined at the time the trust is created.

9. The method of claim 8 wherein the predetermined multiple is a number between eight and twelve.

10. The method of claim 3 wherein the trust and all transactions involving the trust are terminated upon the earlier of a predetermined maturity date or the occurrence of a predetermined triggering event.

11. The method of claim 10 wherein the predetermined maturity date is five years after the formation of the trust.

12. The method of claim 10 wherein the trust purchases securities with the amount invested by investors in the trust.

13. The method of claim 12 wherein a predetermined triggering event is that the mark to market value of the default swap transactions falls below a predetermined trigger level.

14. The method of claim 13 wherein the predetermined trigger level is 60% of the amount invested by the investors in the trust.

15. The method of claim 12 wherein a predetermined triggering event is that the securities purchased by the trust default.

16. The method of claim 10 wherein a predetermined triggering event is that the investors in the trust request termination of the trust.

17. A method of establishing credit protection for a portfolio of reference credits comprising the steps of:
a. entering into a series of credit derivative transactions for each reference credit in an investor-selected portfolio, wherein the investor has invested in a trust an amount less than the notional value of the portfolio and the swap counterparty's recourse in the event of a default of one or more reference credits is limited to the assets of the trust;
b. compensating the investor with a premium that is determined by the entire portfolio of credit derivative transactions;
c. terminating the credit derivative transactions not later than a date certain and earlier than the date certain in the event that the mark-to-market value of the credit derivative transactions falls below a predetermined trigger value.

18. The method of claim 17 wherein the credit derivative transactions are credit default swap transactions.

19. A method for a swap counterparty to obtain credit protection comprising the steps of:
a. obtaining from an investor an investment and a desired portfolio of reference credits for which the swap counterparty is willing to obtain protection;
b. establishing a special purpose vehicle (SPV) that issues securities having the same principal balance as the investment and purchases underlying securities having the same market value as the investment;
d. entering into a series of credit default swap transactions for the portfolio of reference credits, wherein the swap counterparty's recourse in the event of a reference credit default is limited to the assets of the SPV;
d. terminating the SPV and all underlying transactions at a date certain or in the event that the mark-to-market value of the default swaps falls below a predetermined trigger value.

20. The method of claim 19 wherein the SPV is a trust.

21. The method of claim 19 wherein the portfolio is comprised of at least twenty credit references.

22. The method of claim 19 wherein each reference credit in the portfolio has a predetermined minimum credit rating as established by a nationally-recognized statistical rating organization.
